(19) United States
(12) Patent Application Publication
(10) Pub. No.: US 2019/0224768 A1
(43) Pub. Date: Jul. 25, 2019

(54) METHOD OF MANUFACTURING STYLUS

(71) Applicant: MITUTOYO CORPORATION, Kawasaki-shi (JP)

(72) Inventors: Yutaka Tsuchida, Tsuchiura-shi (JP); Reiya Otao, Tsukuba-shi (JP)

(21) Appl. No.: 16/249,240

(22) Filed: Jan. 16, 2019

(30) Foreign Application Priority Data
Jan. 19, 2018 (JP) 2018-007650

(51) Int. Cl. B23H 7/28

(52) U.S. Cl. CPC B23H 7/28

(57) ABSTRACT

The invention relates to a stylus manufacturing method for a contact probe, the stylus including a stick-shaped body, a stem formed continuous to an end of the body and having a diameter smaller than that of the body, and a tip formed continuous to an end of the stem and having a diameter larger than that of the stem. The method includes: primary electrical-discharge-machining of subjecting a leading end of a stick-shaped base material to electrical-discharge-machining to form the tip, a stem end being continuous to the tip and having the same diameter as the stem, and a temporary tapered portion having a diameter increasing from the stem end toward a base end of the base material; polishing of the tip formed in the primary electrical-discharge-machining; and after the polishing, secondary electrical-discharge-machining of subjecting the base material at least at the temporary tapered portion to electrical-discharge-machining to form the stem.

The entire disclosure of Japanese Patent Application No. 2018-007650 filed Jan. 19, 2018 is expressly incorporated by reference herein.

### TECHNICAL FIELD

The present invention relates to a method of manufacturing a stylus of a contact probe.

### BACKGROUND ART

In a typical manufacturing process of mechanical parts, in which the mechanical parts are machined with a high accuracy, the machined mechanical parts are subjected to a profile measurement to check machining results. In such a profile measurement, for instance, a stylus is attached to an end of a contact probe of a coordinate measuring machine and brought into contact with a surface of the mechanical parts. A widely used stylus has an elongated stick-shaped stem and a spherical tip formed at an end of the stem.

Recently, the mechanical parts have been required to be miniaturized into a finer profile. In response, the mechanical parts are machined to have the finer profile. For instance, a deep bore having a diameter of 0.1 mm or less and a depth of 1 mm is formed by fine boring. A stylus used for measuring such a fine shape has miniature stem and tip having the same shapes as the above. The stem and the tip are integrally formed of an ultrahard material that is difficult to machine (see, for instance, Patent Literature 1: JP 2006-231481 A).

A method of machining the ultrahard material that is difficult to machine is exemplified by electrical discharge machining with a wire electrode. However, the electrical discharge machining causes surface roughness of about 1 μm due to machining characteristics. The surface roughness remaining on the formed tip would obstruct a highly accurate measurement. Accordingly, the formed tip is polished to improve a surface accuracy of the tip (see, for instance, Patent Literature 2: JP 2014-237191 A).

When manufacturing the recent miniature stylus, tip polishing involves the following problem.

Specifically, since the stem of the recent miniature stylus has a diameter of about several tens of μm and a length of about several mm, the entire stem is shaped in an extra-fine stick. Accordingly, when the tip is polished after the stylus is formed, the stem, irrespective of being formed of an ultrahard material, is bent by a surface pressure applied by a polishing tool to the tip, so that the tip generates only a slight reaction force. Consequently, the surface pressure required for polishing cannot be obtained. If the polishing tool is further moved toward the tip for a firm contact in order to increase the surface pressure, the stem would be bent larger to be finally broken.

When the tip is polished with the polishing tool in contact with the tip while the tip is rotated, it is expected that an increase in a peripheral velocity of the tip would increase the surface pressure. However, it is difficult to increase a peripheral velocity of an extra-small tip having a diameter of about several tens of μm. Alternatively, the polishing may be conducted for a long processing time with a slight surface pressure. However, such a polishing is not favorable in terms of productivity.

In order to solve the above problem, Patent Literature 2 discloses a method of conducting electrical discharge machining twice and polishing between the first electrical discharge machining and the second electrical discharge machining.

Specifically, as shown in FIG. 9, in the first electrical discharge machining, an end of a stick-shaped base material 200 is machined with a wire electrode 209 to form a roughly shaped portion 201, which is to be formed into a tip, and a slant portion 202 continuous to the roughly shaped portion 201.

Subsequently, as shown in FIG. 10, after the roughly shaped portion 201 is polished into a tip 203 in a final form, the second electrical discharge machining is conducted. In the second electrical discharge machining, the slant portion 202 and an unmachined portion of the base material 200 are machined with the wire electrode 209 to form an elongated stick-shaped stem 204 and a body 205 that is a remaining portion of the base material 200.

When the roughly shaped portion 201 is polished into the tip 203 in this method, a surface pressure can be applied to the roughly shaped portion 201 since the slant portion 202 ensures mechanical strength in a direction intersecting an axial line.

However, in the method disclosed in Patent Literature 2, when the stem 204 is formed by the second electrical discharge machining, swarf 206 generated from the machined part adheres to the finished tip 203. Particularly, when the tip is a flat plate, an area of the flat tip facing the step 204 is larger than an area of the spherical tip 203 facing the step 204, the swarf 206 is more likely to adhere to the flat tip. Adhesion of the swarf 206 to the finished tip 203 results in deterioration of the surface accuracy of the tip 203.

### SUMMARY OF THE INVENTION

An object of the invention is to provide a method of manufacturing a stylus of a contact probe, the method being capable of improving a surface accuracy of a tip.

According to an aspect of the invention, in a method of manufacturing a stylus of a contact probe, the stylus including a stick-shaped body, a stem formed continuous to an end of the body and having a diameter smaller than a diameter of the body, and a tip formed continuous to an end of the stem and having a diameter larger than the diameter of the stem, the method includes: primary electrical discharge machining of subjecting a first end of a stick-shaped base material to electrical discharge machining to form the tip, a stem end being continuous to the tip and having the same diameter as the diameter of the stem, and a temporary tapered portion having a diameter increasing from the stem end toward a second end of the base material; tip polishing of polishing the tip formed in the primary electrical discharge machining; and after the tip polishing, secondary electrical discharge machining of subjecting the base material at least at the temporary tapered portion to electrical discharge machining to form the stem.

In the above aspect of the invention, in the primary electrical discharge machining, the first end of the base material is subjected to electrical discharge machining to form the tip, the stem end to be a part of the later-formed stem, and the temporary tapered portion. In the tip polishing, the tip formed in the primary electrical discharge machining is polished. At the tip polishing, an axial length of the stem end connecting the tip to the unmachined portion of the base material is shorter than an axial length of the entire stem formed later. Accordingly, bending of the stem as observed in a typical technology is less likely to occur. Specifically, the stem end can ensure the mechanical strength (bending strength) in a direction intersecting the axial line, so that the surface pressure for polishing can be reliably applied to the tip.

Moreover, in the above aspect of the invention, in the secondary electrical discharge machining after the tip polishing, the base material at least at the temporary tapered portion is subjected to electrical discharge machining to form the stem. At the beginning of the secondary electrical discharge machining, the temporary tapered portion to be machined is remote from the tip by the axial length of the stem end and is tapered toward the tip. Accordingly, when the temporary tapered portion is machined, a side of the temporary tapered portion relatively close to the tip is machined close to the axial line of the stem, and a side of the temporary tapered portion remote from the tip is machined remote from the axial line of the stem. In other words, when the side of the temporary tapered portion close to the tip is machined, swarf scatters in a narrow range around the axial line of the stem. When the scattering range of swarf expands, the side being machined of the temporary tapered portion is sufficiently remote from the tip. Accordingly, the swarf in the secondary electrical discharge machining is less likely to adhere to the tip.

According to the above process, the surface pressure for polishing the tip can be reliably applied to the tip and the swarf generated by the electrical discharge machining can be prevented from adhering to the tip. Thus, the surface accuracy of the tip is improvable.

In the method according to the above aspect of the invention, an axial length of the stem end is preferably equal to or more than the diameter of the stem and equal to or less than five times as long as the diameter of the stem.

Further, in the method according to the above aspect of the invention, the stem end preferably has the diameter ranging from 20 μm to 30 μm and the axial length ranging from 20 μm to 150 μm.

By the above method, the axial length of the stem end is set so as to more suitably achieve both of ensuring of the mechanical strength in the direction intersecting the axial line, the mechanical strength required for the tip polishing, and prevention of adhesion of the swarf to the tip in the secondary electrical discharge machining.

### BRIEF DESCRIPTION OF DRAWING(S)

FIG. 1 is a perspective view showing a stylus in an exemplary embodiment of the invention.

FIG. 2 is a flowchart showing a method of manufacturing the stylus in the exemplary embodiment.

FIG. 3 is a perspective view showing a base material of the stylus in the exemplary embodiment.

FIG. 4 is a perspective view showing primary electrical discharge machining in the exemplary embodiment.

FIG. 5 is a perspective view showing tip polishing in the exemplary embodiment.

FIG. 6 is a perspective view showing secondary electrical discharge machining in the exemplary embodiment.

FIG. 7 is a perspective view showing primary electrical discharge machining in a modification of the exemplary embodiment.

FIG. 8 is a perspective view showing secondary electrical discharge machining in the modification of the exemplary embodiment.

FIG. 9 is a perspective view showing typical primary electrical discharge machining.

FIG. 10 is a perspective view showing typical tip polishing and typical secondary electrical discharge machining.

### DESCRIPTION OF EMBODIMENT(S)

An exemplary embodiment of the invention will be described below with reference to the attached drawings. The exemplary embodiment provides a method of manufacturing a stylus 1 of a contact probe.

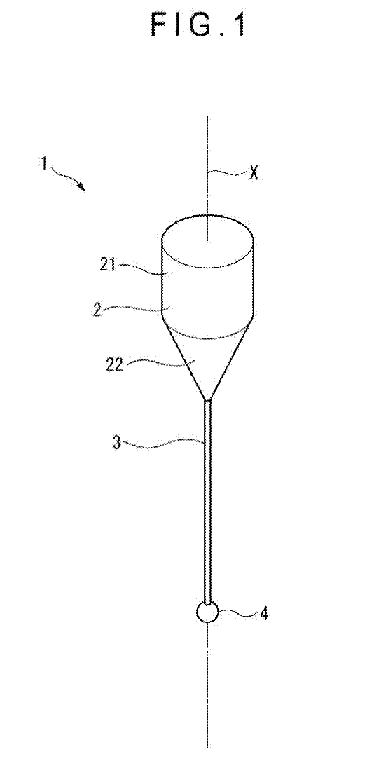

Firstly, a structure of the stylus 1 is briefly described with reference to FIG. 1.

The stylus 1 to be manufactured in the exemplary embodiment includes: a stick-shaped body 2; a stick-shaped stem 3 having a diameter smaller than a diameter of the body 2; and a spherical tip 4 having a diameter smaller than the diameter of the body 2 and larger than the diameter of the stem 3. The body 2, the stem 3 and the tip 4 are coaxial with an axial line X.

The body 2 includes: a large diameter portion 21 shaped in a round stick and attached to a contact probe; and a tapered portion 22 that is tapered from the large diameter portion 21 to the stem 3.

The stem 3 is continuously formed to an end of the tapered portion 22 of the body 2. The diameter of the stem 3 ranges, for instance, from about several μm to about several tens of μm. The length of the stem 3 is, for instance, about several mm. In other words, the stem 3 is shaped in an extra-fine stick as a whole.

The tip 4 is continuously formed to an end of the stem 3. The diameter of the tip 4 is, for instance, about several tens of μm.

The stylus 1 having the above structure is integrally formed of the same material. The material of the stylus 1 is, for instance, an ultrahard metal material.

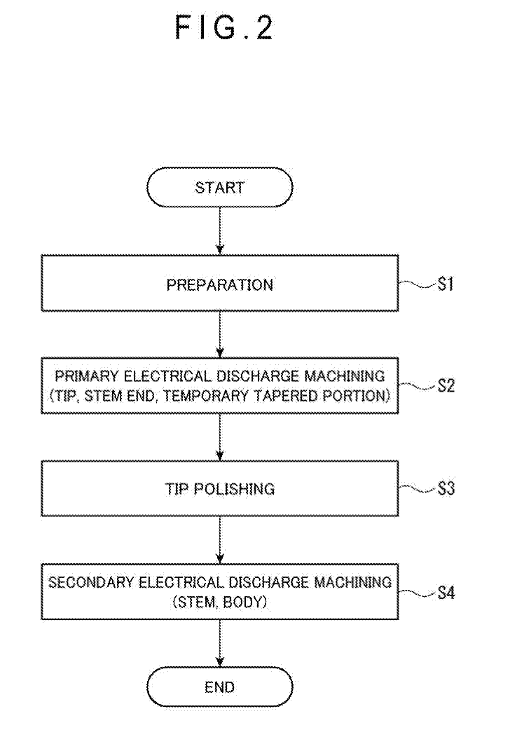

Next, the method of manufacturing the stylus 1 is described with reference to the flowchart of FIG. 2 and FIGS. 3 to 6. In the exemplary embodiment, the stylus 1 is formed by machining a base material 8 with a wire electrode 9 of an electrical discharge machine.

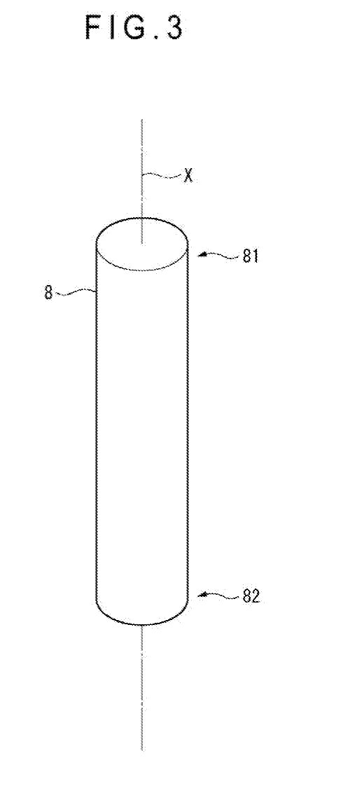

Initially, as shown in FIG. 3, the cylindrical base material 8 is prepared and a base end 81 (one end) of the base material 8 is fixed to a fixture of the electrical discharge machine (preparation step S1 in FIG. 2).

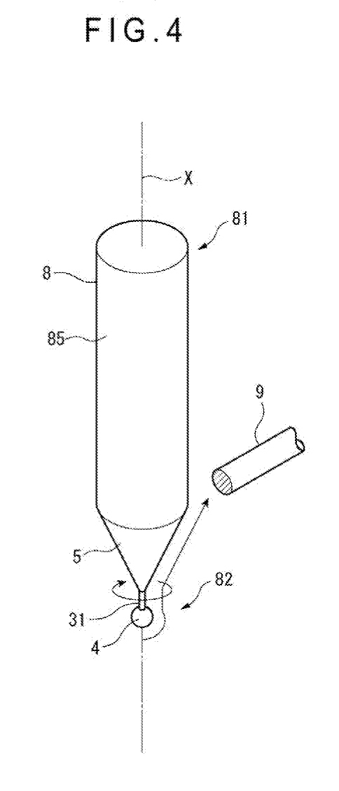

Next, as shown in FIG. 4, while the base material 8 is rotated around the axial line X, the wire electrode 9 to which voltage is applied is brought close to a leading end 82 (the other end) of the base material 8, and moved in a direction from the leading end 82 toward the base end 81 of the base material 8 along an outline of each of target portions to be formed. By this operation, the leading end 82 of the base material 8 is subjected to electrical discharge machining to form the tip 4, a stem end 31, and a temporary tapered portion 5 (primary electrical discharge machining step S2).

The stem end 31, which is formed in the primary electrical discharge machining step S2, is continuous to the tip 4 and has the same diameter as the later-formed stem 3. The stem end 31 becomes a part of a leading end of the stem 3. An axial length of the stem end 31 is preferably longer as long as the stem end 31 can ensure a mechanical strength (bending strength) in a direction intersecting the axial line X, the mechanical strength sufficient for conducting a subsequent tip polishing step S3.

For instance, the axial length of the stem end 31 is equal to or more than a diameter of the stem end 31 whose center is on the axial line X and equal to or less than five times as long as the diameter of the stem end 31. Specifically, the axial length of the stem end 31 ranges from 20 μm to 30 μm, preferably from 20 μm to 150 μm.

The temporary tapered portion 5, which is formed in the primary electrical discharge machining step S2, is a part connecting the stem end 31 to an unmachined portion 85 of the base material 8. A diameter of the temporary tapered portion 5 is increased from the stem end 31 toward the unmachined portion 85. In other words, a cross-sectional area of the temporary tapered portion 5 in the direction intersecting the axial line is gradually increased from the stem end 31 toward the unmachined portion 85.

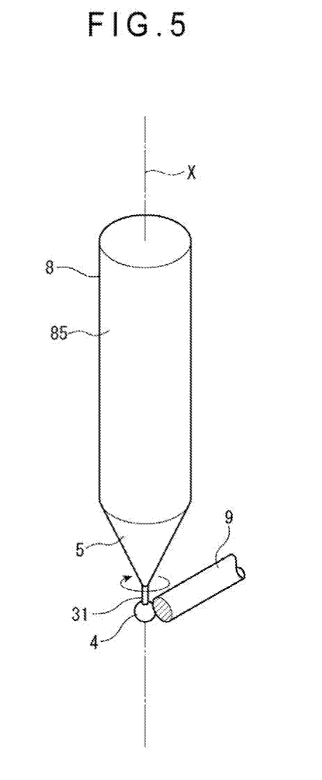

Next, as shown in FIG. 5, a polishing agent is applied to the tip 4 formed in the primary electrical discharge machining step S2, and the wire electrode 9 with no applied voltage is brought into contact with the tip 4 while the base material 8 is rotated around the axial line X. By this operation, the tip 4 is polished (tip polishing step S3 in FIG. 2).

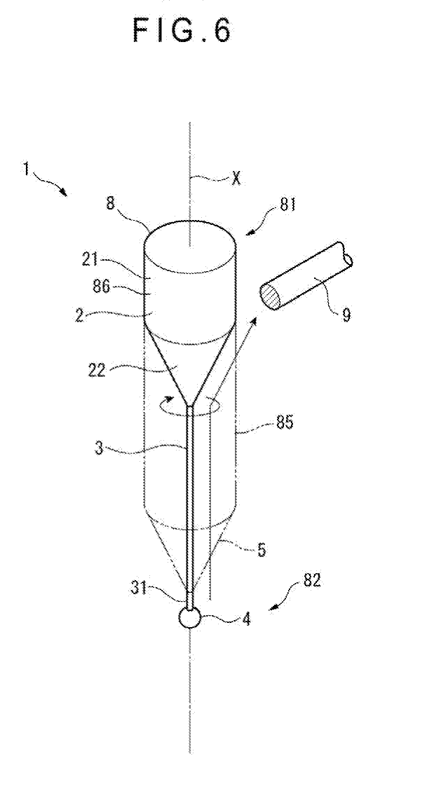

Next, as shown in FIG. 6, after the tip polishing step S3, while the base material 8 is rotated around the axial line X, the wire electrode 9 to which voltage is again applied is brought close to the base material 8, and moved in a direction from the leading end 82 toward the base end 81 of the base material 8 along an outline of each of the rest of the target portions to be formed. By this operation, the temporary tapered portion 5 and the unmachined portion 85 of the base material 8 are subjected to electrical discharge machining to form the stem 3 having a desired length (secondary electrical discharge machining step S4 in FIG. 2).

The large diameter portion 21 of the body 2 may be provided in a form of an unmachined portion 86 remaining on the base material 8 after the stem 3 is formed of the base material 8. Alternatively, the large diameter portion 21 may be formed by the electrical discharge machining as needed.

With the above steps, the stylus 1 of the contact probe shown in FIG. 1 is manufactured.

In the above-described method of manufacturing the stylus in the exemplary embodiment, since the axial length of the stem end 31 connecting the tip 4 to the unmachined portion 85 of the base material 8 is shorter than the axial length of the entire stem 3 subsequently formed, the stem end 31 is less likely to bend at the tip polishing step S3 unlike a typical method of manufacturing the stylus. In other words, the stem end 31 can ensure the mechanical strength (bending strength) in the direction intersecting the axial line, so that a surface pressure for polishing can be reliably applied to the tip 4.

Moreover, at the beginning of the secondary electrical discharge machining step S4 in the exemplary embodiment, the temporary tapered portion 5 to be machined is remote from the tip 4 by the axial length of the stem end 31 and is tapered toward the tip 4. Accordingly, when the temporary tapered portion 5 is machined, a side of the temporary tapered portion 5 relatively close to the tip 4 is close to the axial line X of the stem 3, and a side of the temporary tapered portion 5 remote from the tip 4 is remote from the axial line X of the stem 3. In other words, when the side of the temporary tapered portion 5 close to the tip 4 is machined, swarf scatters in a narrow range around the axial line X of the stem 3. When the scattering range of swarf expands, the side being machined of the temporary tapered portion 5 is sufficiently remote from the tip 4. Accordingly, the swarf in the secondary electrical discharge machining step S4 is less likely to adhere to the tip 4.

Consequently, according to the exemplary embodiment, the surface pressure for the tip polishing can be reliably applied to the tip 4 and the swarf generated by the electrical discharge machining can be prevented from adhering to the tip 4. Thus, the surface accuracy of the tip 4 is improvable.

According to the exemplary embodiment, the axial length of the stem end 31 is set so as to more suitably achieve both of ensuring of the mechanical strength in the direction intersecting the axial line, the mechanical strength required for the tip polishing step S3, and prevention of adhesion of the swarf to the tip 4 in the secondary electrical discharge machining step S4.

According to the exemplary embodiment, in the tip polishing step S3, it is not required to increase the peripheral velocity of the tip 4 from a typical range of the peripheral velocity and to set a long polishing time.

It should be understood that the scope of the invention is not limited to the above exemplary embodiment but includes modifications and improvements as long as the modifications and improvements are compatible with the invention.

In the above exemplary embodiment, the tip 4 is spherical. However, the invention is not limited thereto. The tip 4 may be in any shape.

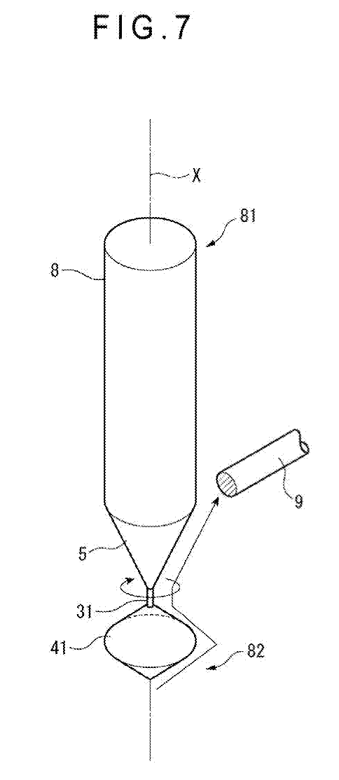

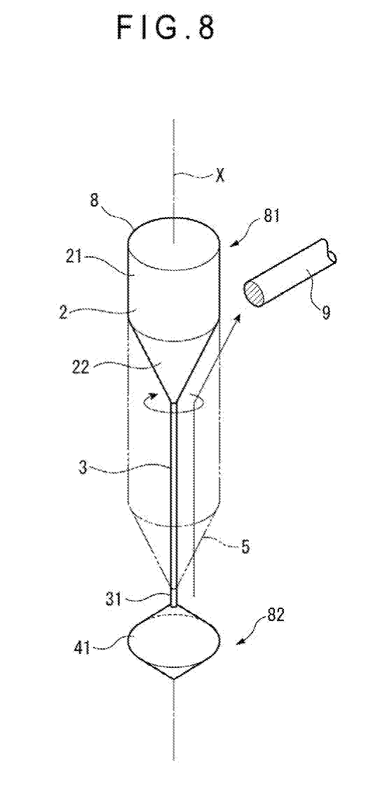

For instance, as shown in FIGS. 7 and 8, a tip 41 may be shaped in a so-called abacus bead such that two oblate cones are connected to each other with the respective bottom surfaces facing each other. In this arrangement, as shown in FIG. 7, after the tip 41, the stem end 31, and the temporary tapered portion 5 are formed in the primary electrical discharge machining step S2, the tip polishing step S3 is conducted. Subsequently, as shown in FIG. 8, the entire step 3 is formed in the secondary electrical discharge machining step S4. In the tip 41 as a modification, an area of the tip 41 facing the stem 3 is larger than an area of the tip 4 facing the stem 3 in the above exemplary embodiment. In this arrangement, swarf is likely to adhere to the tip in the typical method, however, the method of manufacturing the stylus of the invention can suitably prevent swarf from adhering to the tip.

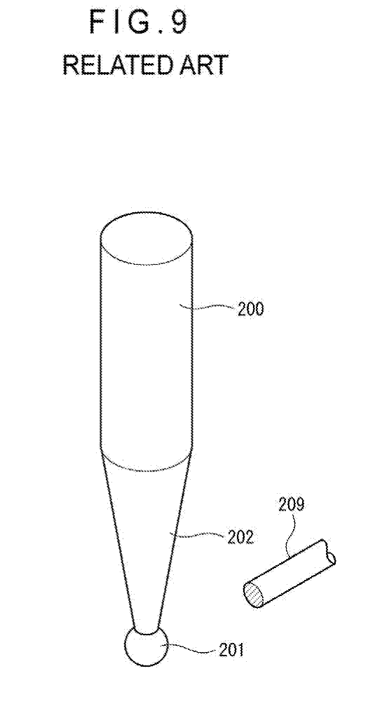

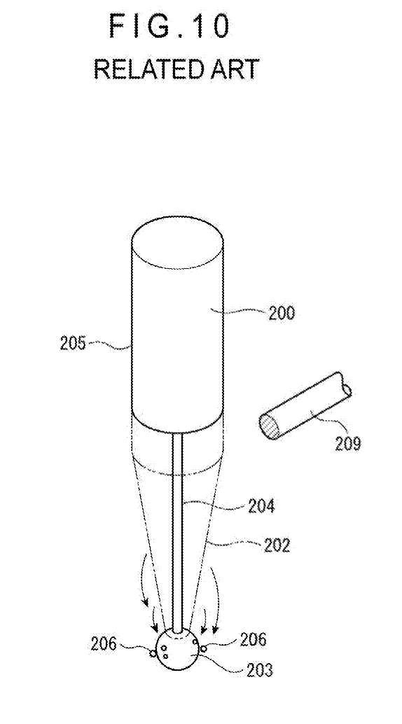

In the above exemplary embodiment, the body 2 includes the large diameter portion 21 and the tapered portion 22. However, the invention is not limited thereto. The body may be in any shape as long as having the diameter larger than that of the stem. For instance, in the same manner as shown in the typical method described with reference to FIGS. 9 and 10, the body may have no tapered portion and the stem may be formed continuous to the round stick-shaped body.

In the above exemplary embodiment, the stem 3 is formed in the secondary electrical discharge machining step S4 by subjecting the temporary tapered portion 5 and the unmachined portion 85 of the base material 8 to the electrical discharge machining. It is only required that the length of the temporary tapered portion 5 and the length of the unmachined portion 85 formed in the primary electrical discharge machining step S2 are suitably set such that a total length of the temporary tapered portion 5, the unmachined portion 85 and the stem end 31 is equal to the desired length of the stem 3. A ratio of the length of the temporary tapered portion 5 relative to the length of the unmachined portion 85 is not limited to 3:7 (see FIG. 6) shown in the above exemplary embodiment, but is 2:8 at which the temporary tapered portion 5 is shortened, or 6:4 at which the unmachined portion 85 is shortened in some exemplary embodiments. Further, the unmachined portion 85 is omitted and a total length of the temporary tapered portion 5 and the stem end 31 is equal to the length of the stem 3 in some exemplary embodiments. In this arrangement, the stem 3 is formed by subjecting only the temporary tapered portion 5 to the electrical discharge machining in the secondary electrical discharge machining step S4.

In the above exemplary embodiment, the tip 4 is polished with the wire electrode 9 in the tip polishing step S3. However, the tip 4 is polished with other polishing tool in some exemplary embodiments.

In the above exemplary embodiment, the wire electrode 9 is moved over the base material 8 in a direction from the leading end 82 toward the base end 81 while the base material 8 is rotated in the primary electrical discharge machining step S2 and the secondary electrical discharge machining step S4. However, the movement of the wire electrode 9 in the invention is not limited thereto. For instance, in some exemplary embodiments, the wire electrode 9 is moved over the base material 8 in a direction from the base end 81 to the leading end 82 while the base material 8 is rotated. Alternatively, in some exemplary embodiments, the base material 8 is moved in the axial line X direction with respect to the wire electrode 9 while the base material 8 is rotated.

What is claimed is:

1. A method of manufacturing a stylus of a contact probe, the stylus comprising a stick-shaped body, a stem formed continuous to an end of the body and having a diameter smaller than a diameter of the body, and a tip formed continuous to an end of the stem and having a diameter larger than the diameter of the stem,
the method comprising:
primary electrical discharge machining of subjecting a first end of a stick-shaped base material to electrical discharge machining to form the tip, a stem end being continuous to the tip and having the same diameter as the diameter of the stem, and a temporary tapered portion having a diameter increasing from the stem end toward a second end of the base material;
tip polishing of polishing the tip formed in the primary electrical discharge machining; and
after the tip polishing, secondary electrical discharge machining of subjecting the base material at least at the temporary tapered portion to electrical discharge machining to form the stem.

2. The method according to claim 1, wherein
an axial length of the stem end is equal to or more than the diameter of the stem and equal to or less than five times as long as the diameter of the stem.

3. The method according to claim 1, wherein
the stem end has the diameter ranging from 20 μm to 30 μm and an axial length ranging from 20 μm to 150 μm.

4. The method according to claim 2, wherein
the stem end has the diameter ranging from 20 μm to 30 μm and the axial length ranging from 20 μm to 150 μm.
